(19) United States
(12) Patent Application Publication
(10) Pub. No.: US 2020/0165083 A1
(43) Pub. Date: May 28, 2020

(54) TRANSPORTING DEVICE, TRANSPORTING SYSTEM, AND SHELF TRANSPORTING METHOD

(71) Applicants: Chau-Lin Huang, Taipei City (TW); Yen-Wen Chen, Taipei City (TW); Chun-Ying Yu, Taipei City (TW)

(72) Inventors: Chau-Lin Huang, Taipei City (TW); Yen-Wen Chen, Taipei City (TW); Chun-Ying Yu, Taipei City (TW)

(73) Assignee: COMPAL ELECTRONICS, INC., Taipei City (TW)

(21) Appl. No.: 16/686,208

(22) Filed: Nov. 18, 2019

Related U.S. Application Data
(60) Provisional application No. 62/770,748, filed on Nov. 22, 2018.

(51) Int. Cl. B65G 67/04; G05D 1/02

(52) U.S. Cl. CPC B65G 67/04; G05D 1/0231; B65G 2203/044; B65G 2201/02; G05D 1/0272

(57) ABSTRACT

The disclosure provides a transporting device, a transporting system, and a shelf transporting method. The method includes: estimating a device pose of the transporting device in a specific field; detecting a shelf pose of a shelf located in the specific field; in response to receiving a transporting request for the shelf, setting an entry point associated with the shelf based on the shelf pose of the shelf, and controlling the transporting device to move to the entry point; in response to determining that the transporting device has arrived at the entry point, rotating to align with the shelf, and entering an accommodating space beneath the shelf via an entrance of the shelf; raising a lift bar to dock with the shelf, and moving to transport the shelf.

### CROSS REFERENCE TO RELATED APPLICATION

This application claims the priority benefit of U.S. provisional application Ser. No. 62/770,748, filed on Nov. 22, 2018. The entirety of the above-mentioned patent application is hereby incorporated by reference herein and made a part of specification.

BACKGROUND

### Technical Field

The disclosure relates to a navigation mechanism, and particularly relates to a transporting device, a transporting system and a shelf transporting method.

### Description of Related Art

Automatic Guided Vehicle (AGV) is a kind of unmanned material conveying means that automatically travels or automatically drags a material box under control of a logistics dispatching system or a manual instruction according to a preset route or a preset map to transport, load, and unload materials.

At present, the existing AGV navigation and control systems in the industry make use of geomagnetic induction guidance, optocoupler tracking guidance, laser reflection guidance, visual tracking guidance, inertial guidance, ultrasonic guidance, etc. However, in the above system, if there are issues of the surroundings that are difficult to handle in the environment where the system is applied (such as mirror reflection on the ground and stains on the road, breakage or blurring of guide lines, etc.), errors such as deviation or loss of the AGV from the path often occur. As a result, the reliability is affected.

### SUMMARY

The disclosure is directed to a transporting device, a transporting system and a shelf transporting method.

The disclosure provides a transporting device including a lift bar and a processor. The lift bar is disposed on a top surface of the transporting device. The processor is configured to: estimate a device pose of the transporting device in a specific field; detect a shelf pose of a shelf located in the specific field; in response to receiving a transporting request for the shelf, set a first entry point associated with the shelf based on the shelf pose of the shelf, and control the transporting device to move to the first entry point; in response to determining that the transporting device has arrived at the first entry point, control the transporting device to rotate to align with the shelf, and enter an accommodating space beneath the shelf via a first entrance of the shelf; raise the lift bar to dock with the shelf, and control the transporting device to move, so as to transport the shelf.

The disclosure provides a transporting system including a shelf and a transporting device. The shelf is located in a specific field, and is provided with a plurality of reflective objects. The transporting device is configured to: estimate a device pose of the transporting device in the specific field; detect a shelf pose of the shelf located in the specific field; in response to receiving a transporting request for the shelf, set a first entry point associated with the shelf based on the shelf pose of the shelf, and move to the first entry point; in response to determining arrival at the first entry point, rotate to align with the shelf, and enter an accommodating space beneath the shelf via a first entrance of the shelf; raise a lift bar to dock with the shelf, and move to transport the shelf.

The disclosure provides a shelf transporting method, suitable for a transporting device. The shelf transporting method includes: estimating a device pose of the transporting device in a specific field; detecting a shelf pose of a shelf located in the specific field; in response to receiving a transporting request for the shelf, setting a first entry point associated with the shelf based on the shelf pose of the shelf, and controlling the transporting device to move to the first entry point; in response to determining that the transporting device has arrived at the entry point, rotating to align with the shelf, and entering an accommodating space beneath the shelf via a first entrance of the shelf; raising a lift bar to dock with the shelf, and moving to transport the shelf.

Based on the above, according to the embodiments of the disclosure, after estimating the device pose of the transporting device itself and the shelf pose of the shelf, the transporting device is controlled to move toward the shelf to dock with the shelf automatically and accurately.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A is a functional block diagram of a transporting device according to an embodiment of the disclosure.

FIG. 1B is a three-dimensional view of the transporting device of FIG. 1A.

FIG. 2A is a schematic diagram of a shelf according to an embodiment of the disclosure.

FIG. 2B is a bottom view of the shelf of FIG. 2A.

FIG. 3 is a flowchart illustrating a shelf transporting method according to an embodiment of the disclosure.

FIG. 4A to FIG. 4G are operation situations of a transporting system located in a specific field according to one embodiment of the disclosure.

### DESCRIPTION OF THE EMBODIMENTS

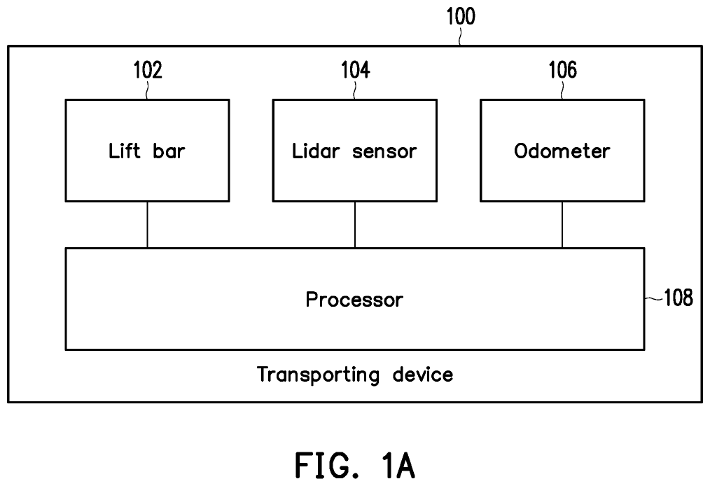

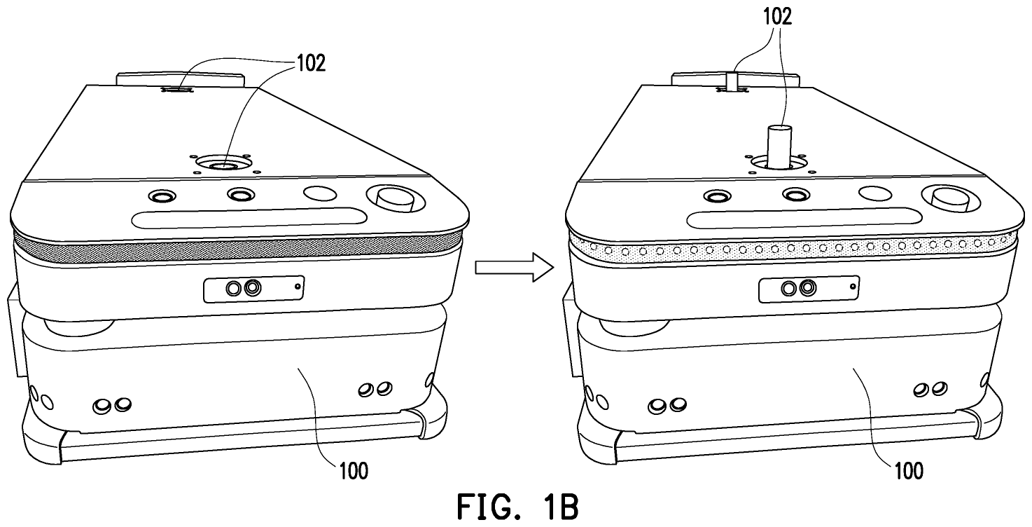

Referring to FIG. 1A and FIG. 1B, FIG. 1A is a functional block diagram of a transporting device according to an embodiment of the disclosure, and FIG. 1B is a three-dimensional view of the transporting device of FIG. 1A. In the embodiment of the disclosure, the transporting device 100 is, for example, an Automatic Guided Vehicle (AGV) that may transport a shelf or other item under control within a specific field (such as a warehouse or other place used for storing goods and shelves), but the disclosure is not limited thereto. For example, when a related control center or a manager controls the transporting device 100 to carry a certain specific shelf, the transporting device 100 may automatically execute a path planner algorithm to plan a path to the specific shelf. Moreover, after reaching a target point near the specific shelf, the transporting device 100 may be automatically switch to a carrot planner algorithm to gradually approach the specific shelf and dock with the specific shelf through a certain manner. After docking with the specific shelf, the transporting device 100 may move the specific shelf to a destination appointed by the control center or the manager through its own movement, thereby completing the transporting operation for the specific shelf.

As shown in FIG. 1A, the transporting device 100 may include a lift bar 102, a lidar sensor 104, an odometer 106 and a processor 108. As shown in FIG. 1B, the lift bar 102 is, for example, disposed on a top surface of the transporting device 100, and may be raised and retracted under control of the processor 108. In an embodiment, the lift bar 102 may be used for docking with a docking part on the shelf to be transported, so as to facilitate transporting the shelf by the handling device 100, but the disclosure is not limited thereto.

The lidar sensor 104 may scan the specific field where the transporting device 100 is located by emitting a light beam (such as laser light), so as to learn distances between objects around the transporting device 100 and the transporting device 100, but the disclosure is not limited thereto. In the embodiment of the disclosure, a plurality of reflective objects (such as reflective strips, reflective labels, etc.) may be arranged on the considered shelf. Therefore, after the lidar sensor 104 scans to obtain a plurality of environmental bright spots in the specific field, it is detected that one or several specific bright spots (for example, a part of environmental bright spots with brightness higher than a brightness threshold) corresponding to the aforementioned reflective objects exist in the environmental bright spots. In the embodiment of the disclosure, the specific bright spots may be used by the transporting device 100 to detect a shelf pose of the shelf (for example, shelf coordinates and a shelf orientation in the specific field), and related details will be described later.

In an embodiment, the transporting device 100 may be provided with a plurality of power wheels that may be driven to rotate and/or move the transporting device 100 (horizontally). In this case, the odometer 106 may be installed on the power wheel to obtain a rotating distance of tyre, thus obtaining an estimated moving distance of the transporting device 100, but the disclosure is not limited thereto. In an embodiment, the transporting device 100 may store a map of the specific field, and therefore the processor 108 may estimate a device pose (for example, including device coordinates and device orientation, etc., of the transporting device 100) of the transporting device 100 in the specific field based on the estimated moving distance obtained by the odometer 106.

The processor 108 is coupled to the lift bar 102, the lidar sensor 104 and the odometer 106, and may be a general purpose processor, a special purpose processor, a traditional processor, a digital signal processor, a plurality of microprocessors, one or a plurality of microprocessors combined with a digital signal processor core, a controller, a micro controller, an Application Specific Integrated Circuit (ASIC), a Field Programmable Gate Array (FPGA), any other type of integrated circuit, a state machine, a processor based on Advanced RISC machine (ARM) and similar device.

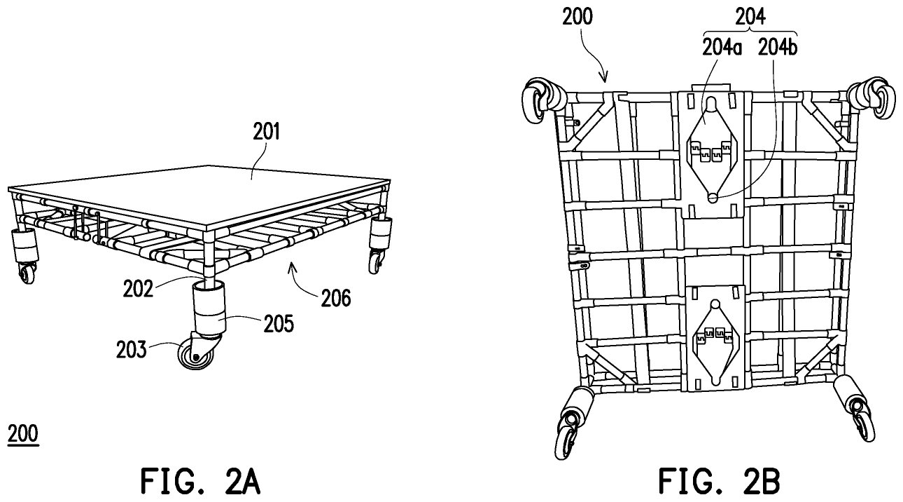

Referring to FIG. 2A and FIG. 2B, FIG. 2A is a schematic diagram of a shelf according to an embodiment of the disclosure, and FIG. 2B is a bottom view of the shelf of FIG. 2A. In the embodiment, the shelf 200 is, for example, located in the aforementioned specific field, and is adapted to be transported by the transporting device 100, but the disclosure is not limited thereto. As shown in FIG. 2A and FIG. 2B, the shelf 200 may include a carrying portion 201, shelf stands 202, wheels 203, a docking portion 204 and a reflective object 205. The carrying portion 201 may be used for carrying goods. The shelf stands 202 may be used for supporting the carrying portion 201, where an end of each of the shelf stands 202 may be connected to the carrying portion 201, and another end thereof may be connected to the wheel 203 to facilitate the transporting device 100 of FIG. 1 to move the shelf 200.

In FIG. 2A, an accommodating space 206 may be formed between the shelf stands 202 below the carrying portion 201. Moreover, as shown in FIG. 2B, the docking portion 204 may be disposed above the accommodating space 206 (or below the carrying portion 201). In the embodiment of the disclosure, the transporting device 100 may enter the accommodating space 206 through the aforementioned carrot planner algorithm, and may be docked with the docking portion 204 through a specific docking operation, thereby achieving the purpose of carrying the shelf 200. In FIG. 2B, the docking portion 204 may include a guiding slot 204a and a position limiting portion 204b, where the position limiting portion 204b may be disposed at at least one end of the guiding slot 204a. In an embodiment, the processor 108 may control the lift bar 102 to stretch into the guiding slot 204a, and control the transporting device 100 to move towards the position limiting portion 204b. In this case, the lift bar 102 may be guided by the guiding slot 204a and position-limited in the position limiting portion 204b, so as to complete the docking operation between the transporting device 100 and the shelf 200, but the disclosure is not limited thereto.

Moreover, the reflective object 205 may be disposed on one or a plurality of the shelf stands 202 to form corresponding specific bright spots after being scanned by the lidar sensor 104, but the disclosure is not limited thereto. In other embodiment, the reflective object 205 may be disposed at any position on the shelf 200 that may be scanned by the lidar sensor 104. In an embodiment, the processor 108 may detect the shelf pose of the shelf 200 in the specific field based on the specific bright spots described above.

In the embodiment of the disclosure, the processor 108 may access/load a specific module and a program code to implement a shelf transporting method provided by the disclosure, which is described in detail below.

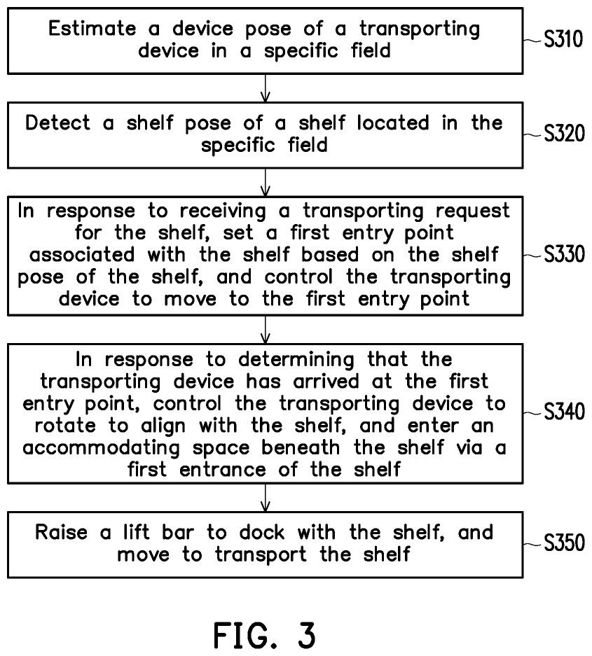

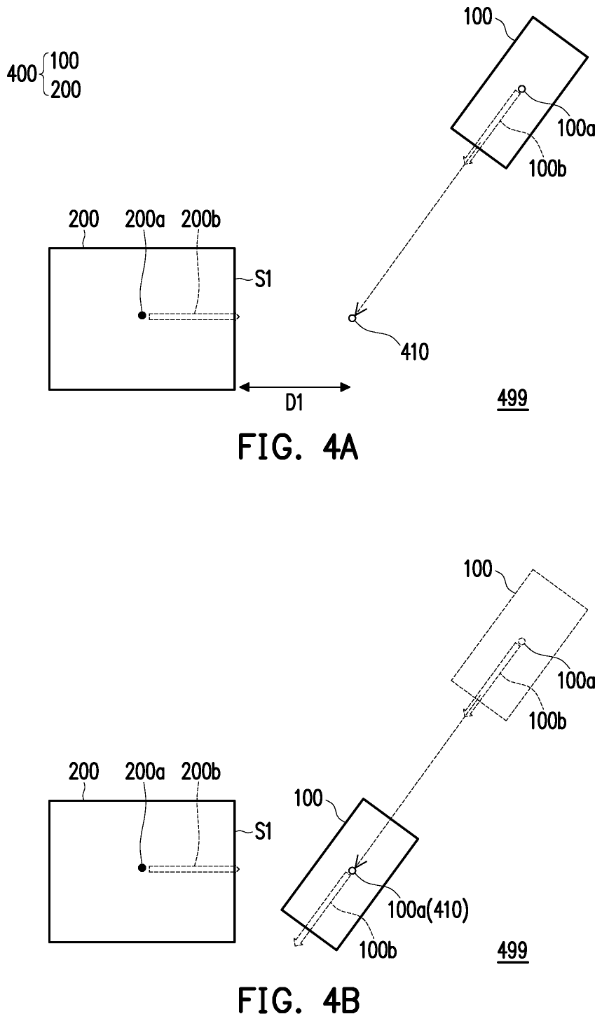

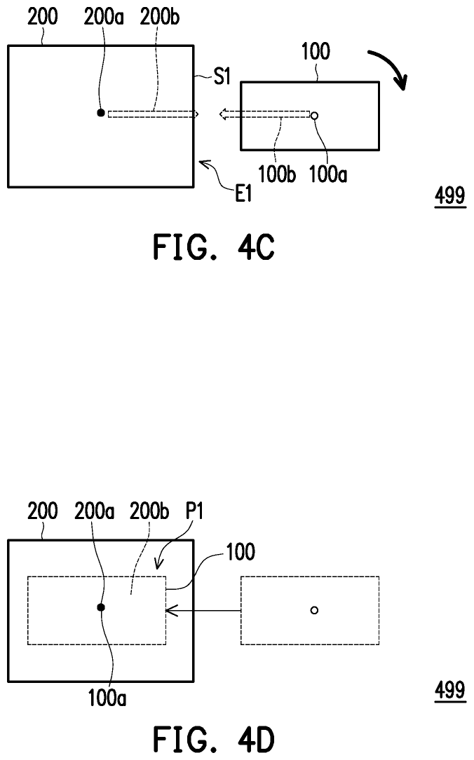

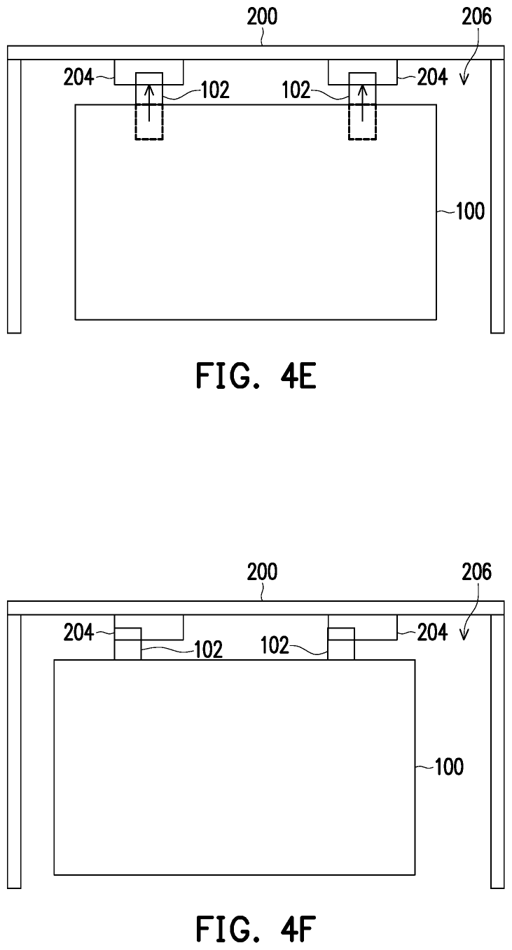

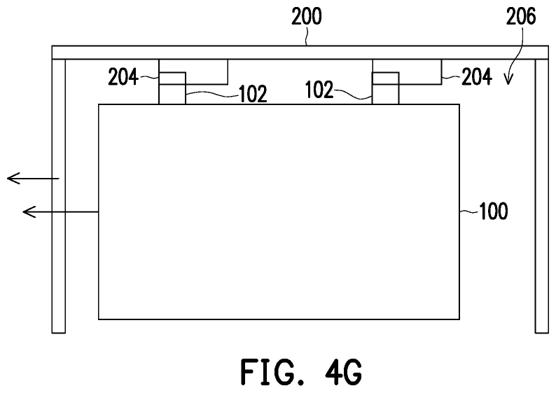

Referring to FIG. 3, FIG. 3 is a flowchart illustrating a shelf transporting method according to an embodiment of the disclosure. The method of the embodiment may be executed by the transporting device 100 of FIG. 1A and FIG. 1B to transport the shelf 200 shown in FIG. 2A and FIG. 2B, and details of each step of FIG. 3 are described below with reference of the content of FIG. 1A to FIG. 2B. Moreover, to facilitate describing the concept of the disclosure, FIG. 4A and FIG. 4B are provided below for assistance, where FIG. 4A and FIG. 4B are the operation situations of a transporting system located in a specific field according to one embodiment of the disclosure.

In a top view of the specific field 499 of FIG. 4A, the transporting system 400 may include the transporting device 100 and the shelf 200, and the transporting system 400 may operate within the specific field 499 (for example, a warehouse). First, in a step S310, the processor 108 estimates a device pose of the transporting device 100 in the specific field 499.

In an embodiment, the processor 108 may control the lidar sensor 104 to scan the specific field 499 to obtain a plurality of environmental bright spots in the specific field 499. Moreover, the processor 108 may further obtain a moving distance of the transporting device 100 in the specific field through the odometer 106, and estimate the device pose of the transporting device 100 (for example, device coordinates and a device orientation 100b of the transporting device 100) in the specific field 499 according to the aforementioned moving distance and the environmental bright spots. In an embodiment, the device coordinates of the transporting device 100 are, for example, coordinates of a reference point 100a on the transporting device 100 (for example, a center point of the transporting device 100) within the specific field 499, but the disclosure is not limited thereto.

In an embodiment, the processor 108, for example, adopts a machine positioning algorithm to estimate the device pose of the transporting device 100 in the specific field 499 based on the aforementioned moving distance and the environmental bright spots. In a different embodiment, the machine positioning algorithm is, for example, a particle filter localization algorithm, an extended Kalman filter localization algorithm, an unscented Kalman filter localization algorithm or other similar algorithm, but the disclosure is not limited thereto.

Then, in a step S320, the processor 108 detects a shelf pose of the shelf 200 located in the specific field 499. In an embodiment, after obtaining the aforementioned environmental bright spots, the processor 108 may obtain a plurality of specific bright spots corresponding to the reflective objects 205 from the environmental bright spots. To be specific, since each of the reflective objects 205 has higher reflectivity than other objects in the specific field, the processor 108 can extract a part of the environmental bright spots with higher brightness from the environmental bright spots to serve as the specific bright spots. For example, the processor 108 may filter the environmental bright spots with brightness lower than a brightness threshold, and take the remained environmental bright spots as the aforementioned specific bright spots, but the disclosure is not limited thereto.

Thereafter, the processor 108 may detect the shelf pose of the shelf 200 (for example, a shelf orientation 200b and shelf coordinates) according to the aforementioned specific bright spots. In an embodiment, the processor 108 may adopt a clustering algorithm to detect a plurality of bright spot clusters corresponding to the reflective objects 205 based on the aforementioned specific bright spots, so as to detect the aforementioned shelf pose, but the disclosure is not limited thereto. In a different embodiment, the clustering algorithm is, for example, a random forest algorithm or other similar algorithm, and may have the ability to identify the shelf 200 presenting different orientations and positions via a certain training procedure.

In an embodiment, the shelf coordinates of the shelf 200 are, for example, coordinates of a reference point 200a on the shelf 200 in the specific field 499. In an embodiment, the reference point 200a is, for example, a center point of the self 200. In another embodiment, the reference point 200a may also be a center point of a wheel axle connected between the aforementioned power wheels, i.e. a position without displacement along with a (horizontal) rotation of the transporting device 100.

Moreover, although only one shelf 200 is illustrated in FIG. 4A, in other embodiments, the processor 108 may simultaneously detect respective shelf poses of a plurality of shelves in the specific field 499 according to the aforementioned instruction.

Then, in a step S330, in response to receiving a transporting request for the shelf 200, the processor 108 sets a first entry point 410 associated with the shelf 200 based on the shelf pose of the shelf 200, and controls the transporting device 100 to move to the first entry point 410. In a different embodiment, the transporting request is, for example, a request from a related logistics system or a manager to request the transporting device 100 to move and transport the shelf 200, but the disclosure is not limited thereto.

In an embodiment, the first entry point 410 is, for example, a virtual point located outside the shelf 200. Taking FIG. 4A as an example, the shelf 200 may have a specific side S1, which is, for example, a short side of the shelf 200, and corresponds to the shelf orientation 200b, but the disclosure is not limited thereto. In FIG. 4A, the first entry point 410 may be spaced apart from the specific side S1 by a predetermined distance D1. To be specific, the first entry point 410 may be spaced apart from a center point of the specific side S1 by the predetermined distance D1, and the predetermined distance D1 may be set to any suitable value according to a designer's experience/demand.

After determining the first entry point 410, the processor 108 may control the transporting device 100 to move to the first entry point 410 until reaching the first entry point 410. In an embodiment, in response to determining that the reference point 100a of the transporting device 100 is aligned with the first entry point 410, the processor 108 may determine that the transporting device 100 has reached the first entry point 410, as shown in FIG. 4B.

In other embodiments, the processor 108 may also adopt other method to determine whether the transporting device 100 has reached the first entry point 410, which is not limited to the method of the above embodiment. For example, the processor 108 may determine whether the transporting device 100 has reached the first entry point 410 by determining whether other appointed position on the transporting device 100 have aligned with the first entry point 410, but the disclosure is not limited thereto.

In other embodiments, during the process that the transporting device 100 moves to the first entry point 410, the processor 108 may also continuously obtain the device poses of the transporting device 100 in the manner taught in the previous embodiment, so as to ensure that the transporting device 100 has properly advanced toward the first entry point 410, but the disclosure is not limited thereto.

Moreover, in an embodiment, the transporting device 100 may have at least two moving modes, such as a normal moving mode and a docking mode, and a main difference there between is that a moving speed of the normal moving mode is higher than a moving speed of the docking mode. In order to make the transporting device 100 to access the shelf 200 more quickly, the processor 108 may control the transporting device 100 to go to the first entry point 410 in the normal moving mode. After reaching the first entry point 410, the processor 108 may control the transporting device 100 to switch to the docking mode, so as to dock with the shelf 200 in a slower and more delicate manner, but the disclosure is not limited thereto.

In a step S340, in response to determining that the transporting device 100 has arrived at the first entry point 410, the processor 108 controls the transporting device 100 to rotate to align with the shelf 200, and enter the accommodating space 206 beneath the shelf 200 via a first entrance E1 of the shelf 200. As shown in FIG. 4C, after the transporting device 100 arrives at the first entry point 410, the processor 108 may control the transporting device 100 to rotate until the device orientation 100b is aligned with the shelf orientation 200b. In an embodiment, in response to determining that the device orientation 100b is aligned with the shelf orientation 200b, the processor 108 may determine that the transporting device 100 is aligned with the shelf 200. In an embodiment, the processor 108 may also switch the transporting device 100 to the docking mode after the transporting device 100 is aligned with the shelf 200, but the disclosure is not limited thereto.

In the embodiment, the first entrance E1 is, for example, an entrance formed by two shelf stands 202 on the specific side S1, and has a size allowing the transporting device 100 to pass through. Therefore, after the transporting device 100 is aligned with the shelf 200, the processor 108 may control the transporting device 100 to enter the accommodating space 206 under the shelf 200 through the first entrance E1 of the shelf 200.

As shown in FIG. 4D, the processor 108 may control the transporting device 100 to move to a docking position P1 in the accommodating space 206, so that the lift bar 102 is located below the docking portion 204. In an embodiment, in response to determining that the reference point 100a of the transporting device 100 is aligned with the center point of the shelf 200 (for example, the reference point 200a), the processor 108 may determine that the transporting device 100 has reached the docking position P1 within the accommodating space 206, but the disclosure is not limited thereto.

In an embodiment, during the process that the transporting device 100 moves to the docking position P1, the processor 108 may also continuously obtain the device poses of the transporting device 100 and the shelf poses of the shelf 200 to confirm whether the poses of the transporting device 100 and the shelf 200 are consistent with the previously detected poses. In an embodiment, if the inconsistent device/shelf pose is detected, the processor 108 may control the transporting device 100 to re-execute the docking operation with the shelf 200. For example, the processor 108 may re-obtain the first entry point of the shelf 200, and control the transporting device 100 to move to the new first entry point. Thereafter, the processor 108 may again control the transporting device 100 to move to the docking position P1 in the accommodating space 206 of the shelf 200 based on the previous instructions, but the disclosure is not limited thereto.

Thereafter, in a step S350, the processor 108 raises the lift bar 102 to dock with the shelf 200, and controls the transporting device 100 to move, so as to move the shelf 200. Referring to FIG. 4E, FIG. 4E is a simple side view of FIG. 4D. As shown in FIG. 4E, after the transporting device 100 reaches the docking position P1 in the accommodating space 206, the processor 108 may raise the lift bar 102 to stretch the lift bar 102 into the docking portion 204 of the shelf 200. Thereafter, as described above, the processor 108 may control the transporting device 100 to move towards the position limiting portion 204b of the docking portion 204, so that the lift bar 102 is guided by the guiding slot 204a and position-limited in the position limiting portion 204b, so as to complete the docking between the transporting device 100 and the shelf 200, as shown in FIG. 4F.

In an embodiment, during the process that the processor 108 controls to raise the lift bar 102, the processor 108 may monitor whether the lift bar 102 has been successfully raised to a specified height, which is, for example, the maximum height that the lift bar 102 may reach, but the disclosure is not limited thereto. If the lift bar 102 is unable to be successfully raised to the specified height, it represents that the transporting device 100 may not have correctly moved to the required docking position P1. Therefore, the processor 108 may control the transporting device 100 to re-execute the docking operation with the shelf 200. For example, the processor 108 may re-obtain the first entry point of the shelf 200, and control the transporting device 100 to move to the first entry point. Thereafter, the processor 108 may again control the transporting device 100 to move to the docking position P1 in the accommodating space 206 of the shelf 200 based on the previous instructions, but the disclosure is not limited thereto.

Thereafter, the processor 108 may control the transporting device 100 to move, so as to drive the shelf 200 to move to the destination specified by the aforementioned transporting request. Moreover, in an embodiment, after completing the docking between the transporting device 100 and the shelf 200, the processor 108 may switch the transporting device 100 to the normal moving mode, so as to quickly move the shelf 200 to the destination, but the disclosure is not limited thereto.

Moreover, in an embodiment, after the transporting device 100 moves the shelf 200 to the specified destination, the processor 108 may retract the lift bar 102 to release the docking relationship with the shelf 200, so that the transporting device 100 may move to other shelves in response to other transporting requests.

It should be noted that the situations shown in the above diagrams are only used as an example, and are not intended to limit implementations of the disclosure. For example, in other embodiments, the lift bar and the docking portion may also adopt other shapes, positions, sizes, amounts and structures for implementation, as long as the lift bar may form a stable connection relationship with the docking portion after the lift bar is raised, so that the disclosure is not limited to the aforementioned disclosed pattern. For example, the lift bar may be designed as a round bar, and the docking portion may be correspondingly designed as a groove in size and shape of to fit the aforementioned round bar. In this way, after the lift bar is stretched into the docking portion, the lift bar may be clamped in the docking portion to form a stable connection relationship, so that the shelf may move stably along with movement of the transporting device.

In summary, the shelf transporting method, the transporting system and the transporting device provided by the disclosure may respectively obtain the device pose of the transporting device and the shelf pose of the shelf through a machine positioning algorithm and a clustering algorithm. Moreover, in the disclosure, since it is only required to set the reflective objects on the shelf (the shelf stands) to make the transporting device to obtain the shelf pose through the above algorithms, no excessive installation and/or deployment operation is required, and at least one lidar sensor is needed to detect multiple shelves all at one time.

Then, when the transporting request is received for transporting the shelf, the transporting device may determine the first entry point outside the shelf based on its own device pose and the shelf pose of the shelf, and accordingly moves to the first entry point. After reaching the first entry point, the transporting device may rotate to align with the shelf, and continually move to the docking position in the accommodating space. After reaching the docking position, the transporting device may raise the lift bar to dock with the docking portion on the shelf. After the transporting device completes docking with the shelf, the transporting device may move to transport the shelf to the destination.

It is learned from the above description that in case that the reflective objects are configured on the shelf, the transporting device of the disclosure may obtain the device pose and the shelf pose only based on the readings of the odometer and the lidar sensor, so as to automatically implement the docking and transporting operations for the shelf.

It will be apparent to those skilled in the art that various modifications and variations can be made to the disclosed embodiments without departing from the scope or spirit of the disclosure. In view of the foregoing, it is intended that the disclosure covers modifications and variations provided they fall within the scope of the following claims and their equivalents.

What is claimed is:

1. A transporting device, comprising:
a lift bar, disposed on a top surface of the transporting device; and
a processor, configured to:
estimate a device pose of the transporting device in a specific field;
detect a shelf pose of a shelf located in the specific field;
in response to receiving a transporting request for the shelf, set a first entry point associated with the shelf based on the shelf pose of the shelf, and control the transporting device to move to the first entry point;
in response to determining that the transporting device has arrived at the first entry point, control the transporting device to rotate to align with the shelf, and enter an accommodating space beneath the shelf via a first entrance of the shelf; and
raise the lift bar to dock with the shelf, and control the transporting device to move, so as to transport the shelf.

2. The transporting device as claimed in claim 1, wherein the shelf is provided with a plurality of reflective objects, and the transporting device further comprises a lidar sensor, wherein the lidar sensor is configured to scan the specific field where the transporting device is located to obtain a plurality of environmental bright spots in the specific field, and the processor is configured to:
obtain a plurality of specific bright spots corresponding to the reflective objects from the environmental bright spots; and
detect the shelf pose of the shelf based on the specific bright spots.

3. The transporting device as claimed in claim 2, wherein the transporting device further comprises an odometer, wherein the odometer is configured to obtain a moving distance of the transporting device, and the processor is configured to:
estimate a device pose of the transporting device in the specific field based on the moving distance and the environmental bright spots.

4. The transporting device as claimed in claim 3, wherein the device pose comprises device coordinates and a device orientation of the transporting device in the specific field, and the processor is configured to adopt a machine positioning algorithm to estimate the device pose of the transporting device in the specific field based on the moving distance and the environmental bright spots.

5. The transporting device as claimed in claim 2, wherein a brightness of each of the specific bright spots is higher than a brightness threshold.

6. The transporting device as claimed in claim 2, wherein the shelf pose of the shelf comprises shelf coordinates and a shelf orientation of the shelf in the specific field, and the processor is configured to:
adopt a clustering algorithm to detect a plurality of bright spot clusters corresponding to the reflective objects based on the specific bright spots and thereby detect the shelf pose.

7. The transporting device as claimed in claim 2, wherein the shelf comprises a plurality of shelf stands, each of the shelf stands has a wheel, and the reflective objects are disposed on the shelf stands.

8. The transporting device as claimed in claim 7, wherein the shelf has a carrying portion, the carrying portion is located above the accommodating space, and a docking portion for accommodating the lift bar is provided between the carrying portion and the accommodating space.

9. The transporting device as claimed in claim 1, wherein the first entrance is located at a specific side of the shelf, the first entry point is a virtual point outside the shelf, and the virtual point and the specific side are spaced apart by a predetermined distance.

10. The transporting device as claimed in claim 1, wherein in response to determining that a reference point on the transporting device is aligned with the first entry point, the processor determines that the transporting device has arrived at the first entry point.

11. The transporting device as claimed in claim 10, wherein the transporting device comprises a plurality of power wheels connected through a wheel axle, and the reference point corresponds to a wheel axle center point of the wheel axle.

12. The transporting device as claimed in claim 1, wherein in response to determining that the transporting device has arrived at the first entry point, the processor is configured to switch a moving configuration of the transporting device from a normal moving mode to a docking mode, and after the lift bar is raised to dock with the shelf, the processor is further configured to switch the moving configuration of the transporting device from the docking mode to the normal moving mode, wherein a moving speed corresponding to the normal moving mode is higher than a moving speed corresponding to the docking mode.

13. The transporting device as claimed in claim 1, wherein the device pose comprises a device orientation of the transporting device, the shelf pose of the shelf comprises a shelf orientation of the shelf, and the processor is configured to:
obtain the shelf orientation of the shelf to accordingly rotate the transporting device;
in response to determining that the device orientation is aligned with the shelf orientation of the shelf, determine that the transporting device is aligned with the shelf.

14. The transporting device as claimed in claim 1, wherein the shelf has a carrying portion, a docking portion corresponding to the lift bar is provided above the accommodating space, and the processor is configured to:
control the transporting device to move to a docking position in the accommodating space, so that the lift bar is located below the docking portion; and
raise the lift bar to stretch the lift bar into the docking portion, so as to dock with the shelf.

15. The transporting device as claimed in claim 14, wherein the docking portion comprises a guiding slot, and an end of the guiding slot is provided with a position limiting portion, wherein after the processor raises the lift bar to stretch the lift bar into the docking portion, the processor is further configured to control the transporting device to move towards the position limiting portion until the lift bar is guided by the guiding slot and position-limited in the position limiting portion.

16. The transporting device as claimed in claim 14, wherein in response to determining that that the lift bar is unable to be raised to a specific height, the processor is further configured to control the transporting device to dock with the shelf again.

17. The transporting device as claimed in claim 14, wherein in response to determining that a reference point of the transporting device is aligned with a center point of the shelf, the processor determines that the transporting device has arrived at the docking position in the accommodating space.

18. A transporting system, comprising:
a shelf, located in a specific field, and provided with a plurality of reflective objects; and
a transporting device, configured to:
estimate a device pose of the transporting device in the specific field;
detect a shelf pose of the shelf located in the specific field;
in response to receiving a transporting request for the shelf, set a first entry point associated with the shelf based on the shelf pose of the shelf, and move to the first entry point;
in response to determining arrival at the first entry point, rotate to align with the shelf, and enter an accommodating space beneath the shelf via a first entrance of the shelf; and
raise a lift bar to dock with the shelf, and move to transport the shelf.

19. A shelf transporting method, suitable for a transporting device, the shelf transporting method comprising:
estimating a device pose of the transporting device in a specific field;
detecting a shelf pose of a shelf located in the specific field;
in response to receiving a transporting request for the shelf, setting a first entry point associated with the shelf based on the shelf pose of the shelf, and controlling the transporting device to move to the first entry point;
in response to determining that the transporting device has arrived at the first entry point, rotating to align with the shelf, and entering an accommodating space beneath the shelf via a first entrance of the shelf; and
raising a lift bar to dock with the shelf, and moving to transport the shelf.
